(19) United States
(12) Patent Application Publication
(10) Pub. No.: US 2008/0126372 A1
(43) Pub. Date: May 29, 2008

(54) Cyclic redundant multiple computer architecture

(76) Inventor: John M. Holt, Exxex (GB)

Correspondence Address: PERKINS COIE LLP, P.O. BOX 2168, MENLO PARK, CA, 94026, US

(21) Appl. No.: 11/973,340

(22) Filed: Oct. 5, 2007

Related U.S. Application Data
(60) Provisional application No. 60/850,504, filed on Oct. 9, 2006.
(60) Provisional application No. 60/850,532, filed on Oct. 9, 2006.

(30) Foreign Application Priority Data
Oct. 5, 2006 (AU) 2006905523
Oct. 5, 2006 (AU) 2006905529

(51) Int. Cl. G06F 15/16; G06F 17/30

(52) U.S. Cl. 707/100; 709/201; 707/E17.044

(57) ABSTRACT

A multiple computer system incorporating redundancy is disclosed. Data to be stored (A, B, C) is distributed (A1, A2, A3, . . . B1, B2, B3, . . . C1, C2, C3, . . . ) amongst a multiplicity of computers (M1, M2, . . . Mn). A parity form (P[A], P[B], . . . ) of the stored data is created by use of a reversible encoding process. The parity form data is preferably cycled amongst the various computers. In the event of failure of one of the computers the lost data can be re-generated.

### CROSS REFERENCE TO RELATED APPLICATIONS

The present application claims the benefit of priority to U.S. Provisional Application Nos. 60/850,504 (5027CU-US) and 60/850,532 (5027W-US), both filed 9 Oct. 2006; and to Australian Provisional Application Nos. 2006905523 (5027CU-AU) and 2006905529 (5027W-AU), both filed on 5 Oct. 2006, each of which are hereby incorporated herein by reference.

This application is related to concurrently filed U.S. Application entitled “Cyclic Redundant Multiple Computer Architecture,” (Attorney Docket No. 61130-8034.US01 (5027CU-US01)) and concurrently filed U.S. Application entitled “Cyclic Redundant Multiple Computer Architecture,” (Attorney Docket No. 61130-8034.US02 (5027CU-US02)), each of which are hereby incorporated herein by reference.

### FIELD OF THE INVENTION

The present invention relates to multiple computer systems and to single computers operating in a multiple computer system environment. In particular, the invention relates to the provision of redundancy in multiple computer systems.

### BACKGROUND

Ideally, redundancy is provided in a multiple computer system so that in the event that one computer fails, the data which is stored in the local memory of the failed computer is preserved on another computer.

Hitherto, such redundancy has not been available. For example, in super computing a “checkpoint” system is used. Under this arrangement at predetermined intervals of, say, every hour or after some predetermined or dynamically determined number of operations have been performed, executing stops and a permanent record is made of the current status and current data of each computer. As a consequence, in the event of a failure, it is necessary to stop all computers, restore the status and data as of the last checkpoint, and then with a replaced computer, or a repaired computer, recommence executing instructions as of the last checkpoint.

Another form of multiple computer system is that known as Distributed Shared Memory (DSM). Here individual computers are interconnected by means of a communications network or some other equivalent communications link and the local memory of each of the computers is accessible by any one of the other computers. Hitherto in DSM computing redundancy has not been possible.

A different form of multiple computer system has recently been described, but not commercially used, and this is known as Replicated Shared Memory (RSM). This system is described in International Patent Application No. PCT/AU2005/000580 (Attorney Ref 5027F-WO) published under WO 2005/103926 (to which U.S. patent application Ser. No. 11/111,946 and published under No. 2005-0262313 corresponds) in the name of the present applicant. This specification discloses how different portions of an application program written to execute on only a single computer can be operated substantially simultaneously on a corresponding different one of a plurality of computers. That simultaneous operation has not been commercially used as of the priority date of the present application. International Patent Application Nos. PCT/AU2005/001641 (WO2006/110937 (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds and PCT/AU2006/000532 (WO2006/110957) (Attorney Ref: 5027F-D2-WO) both in the name of the present applicant and both unpublished as at the priority date of the present application, also disclose further details. The contents of the specification of each of the abovementioned prior application(s) are hereby incorporated into the present specification by cross reference for all purposes.

Briefly stated, the abovementioned patent specifications disclose that at least one application program written to be operated on only a single computer can be simultaneously operated on a number of computers each with independent local memory. The memory locations required for the operation of that program are replicated in the independent local memory of each computer. On each occasion on which the application program writes new data to any replicated memory location, that new data is transmitted and stored at each corresponding memory location of each computer. Thus apart from the possibility of transmission delays, each computer has a local memory the contents of which are substantially identical to the local memory of each other computer and are updated to remain so. Since all application programs, in general, read data much more frequently than they cause new data to be written, the abovementioned arrangement enables very substantial advantages in computing speed to be achieved. In particular, the stratagem enables two or more commodity computers interconnected by a commodity communications network to be operated simultaneously running under the application program written to be executed on only a single computer.

### GENESIS OF THE INVENTION

The genesis of the present invention is a desire to provide at least some redundancy in multiple computer systems.

### SUMMARY OF THE INVENTION

According to a first aspect of the present invention there is disclosed a method of storing data in a multiple computer system comprising a multiplicity of computers each having an independent local memory and each being interconnected to the other computers via a communications network, said method comprising the steps of:

(i) partitioning the local application memory of each computer into a corresponding multiplicity of application memory compartments,
(ii) dividing data created by, or required for, the operation of said multiple computers into a plurality of groups being one less in number than the number of compartments,
(iii) applying a reversible encoding technique to each of said data groups to create an additional data group comprising a decodable encoding of the other groups, and
(iv) storing a different one of each of said groups in a corresponding compartment in each said computer,
whereby in the event of failure of only one of said computers said divided data can be re-constituted from the data stored in the remaining computers.

According to second aspect of the present invention there is disclosed a multiple computer system comprising a multiplicity of computers each having an independent local memory and each being interconnected to the other computers via a communications network, the local application memory of each computer being partitioned into a corresponding multiplicity of application memory compartments, data division means to divide data created by, or required for, the operation of said multiple computers into a plurality of groups being one less in number than the number of said compartments, and data encoding means to create an additional data group comprising a decodable encoding of the other groups, wherein a different one of each of said groups is stored in a corresponding compartment in each said computer, whereby in the event of failure of only one of said computers said divided data can be reconstituted from the data stored in the remaining computers.

According to a third aspect of the present invention there is disclosed a single computer for use with an external multiple computer system including a multiplicity of computers, the single computer comprising an independent local memory partitioned into a multiplicity of application memory compartments corresponding to the multiplicity of computers in the multiple computer system, and a communications port adapted for coupling with an external network for interconnection with the external multiple computer system, said communications port receiving a divided data comprising a number of different data groups each corresponding to several different portions of data and each including an additional data group.

### BRIEF DESCRIPTION OF THE DRAWINGS

Embodiments of the present invention will now be described with reference to the drawings in which:

FIG. 1 is a schematic representation of a prior art Redundant Array of Independent Disks (RAID) in which static data is able to be stored in a redundant matter,

FIG. 2 is a schematic representation of a prior art DSM multiple computer system,

FIG. 3A is a schematic illustration of a prior art computer arranged to operate JAVA code and thereby constitute a single JAVA virtual machine,

FIG. 3B is a drawing similar to FIG. 3A but illustrating the initial loading of code,

FIG. 3C illustrates the interconnection of a multiplicity of computers each being a JAVA virtual machine to form a multiple computer system,

FIG. 4 schematically illustrates “n” application running computers to which at least one additional server machine X is connected,

FIG. 4A is a schematic representation of an RSM multiple computer system,

FIG. 4B is a similar schematic representation of a partial or hybrid RSM multiple computer system,

FIG. 5 is a schematic representation of one embodiment of a multiple computer system,

FIG. 6 is a view similar to FIG. 5 and illustrating another embodiment in the form of a partial replicated shared memory system, and

FIG. 7 is a further embodiment of a partial replicated shared memory system incorporating redundancy.

### DETAILED DESCRIPTION

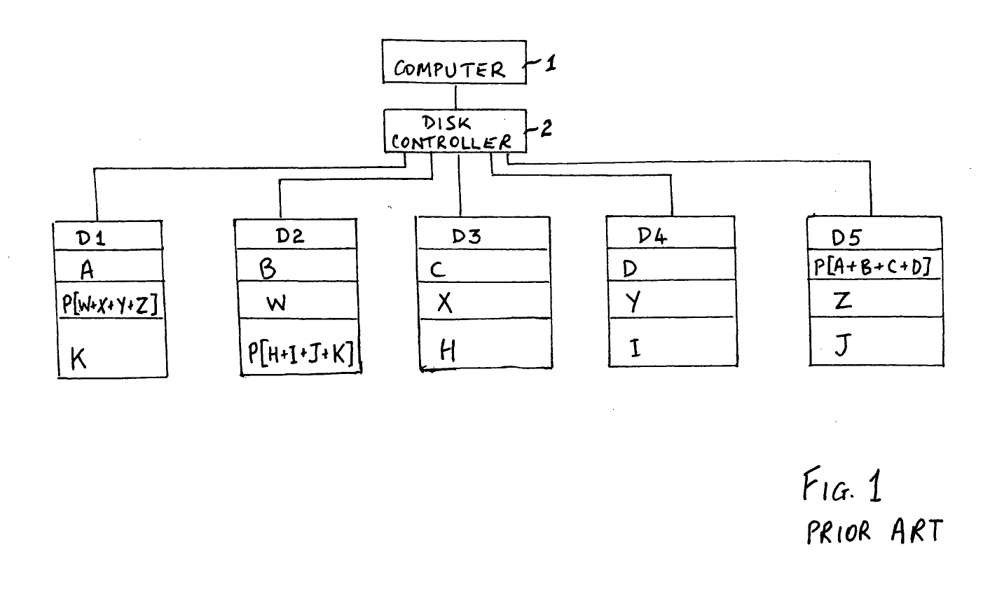

In computing tasks where continued access to stored data on a disk drive storage device is crucial, it is known to provide disk drive redundancy by means of a Redundant Array of Independent Disks (RAID) and such an arrangement is schematically illustrated in FIG. 1. It is important to note in this connection that the redundancy of the disk drive is in relation to failure of a single disk and has nothing to do with the failure of the computer which needs to access the data stored on the disk. It is also noted that the data is static in the sense that the data once written to the disk does not change and is persistent until it is eventually overwritten.

In the arrangement illustrated in FIG. 1, a computer 1 is connected to a disk drive controller 2 which is in turn connected to five disks D1-D5. Data from the computer 1 is sent to the disk controller 2 where a decision is made as to what data to store on which disk. Some data A is stored on disk D1, some data B is stored on disk D2, some data C is stored on disk D3, and some data D is stored on disk D4. In order to provide redundancy, some additional data, which is conventionally termed parity data, is stored on disk D5 and this is indicated as P[A+B+C+D]. The concept of parity is well known in computing. In order to give a trivial example, if the value of A is 12, the value of B is 13, the value of C is 14, and the value of D is 15 then utilising a simple parity algorithm what is stored on disk D5 is the sum 54 of these four individual pieces of data. As a consequence, if for any reason disk 1, for example, were to fail, then it would be possible to reconstitute the data A by taking the value of the data stored on disk D5 (54) and subtracting 13, 14, and then 15 in turn from this total to arrive at the original figure for A. This is an example of a reversible encoding technique. The concept of parity in computing is well known and is not therefore discussed further.

In FIG. 1, each of the disks, D1-D5 are shown as having only three data locations. In the second data location are stored data W, X, Y, and Z and their sum in disks D2-D5 and D1 respectively. Similarly, data H, I, J, and K are stored on disks D3, D4, D5, and D1 respectively whilst their sum is stored on disk D2. This arrangement distributes the stored sums, or parity data, amongst the various disks and this is advantageous since it evens out the storage requirement between disks. That is, it would be possible to store the data A, the data W and the data H for example all on disk D1 and store all the parity data on disk D5 but this arrangement is generally undesirable.

The abovementioned arrangement provides an acceptable level of redundancy, particularly where a delay can be tolerated between the time of failure and the time at which operation of the data store can re-commence. However, it should be noted that the computer 1 is not a multiple computer system and that the redundancy is only in respect of the static data stored on the disks and so the RAID system does not provide any assistance in the event of the failure of computer 1 or the disk controller controlling the failed disk drive.

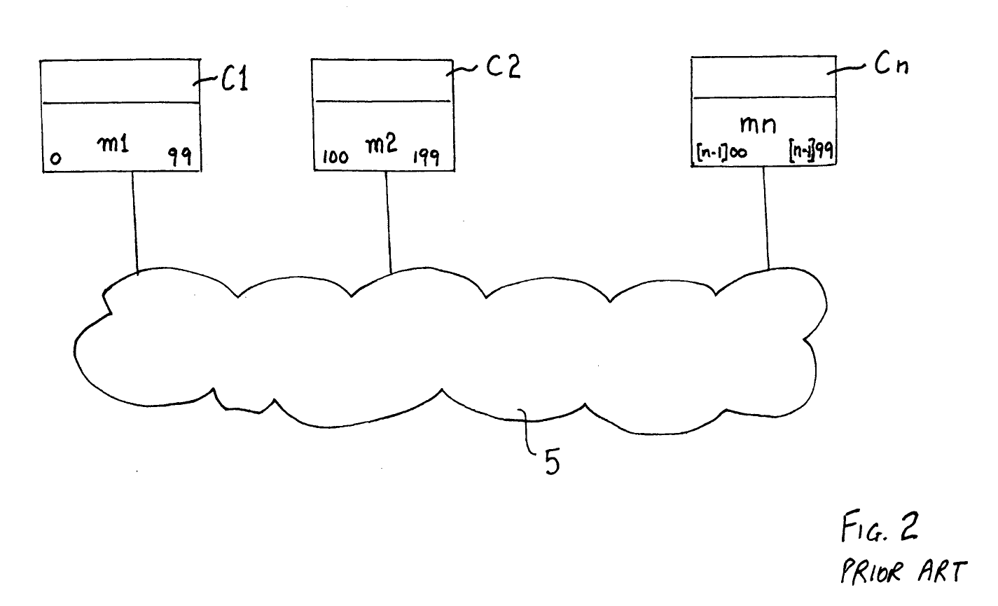

Turning now to FIG. 2, a known multiple computer system utilizing distributed shared memory (DSM) is illustrated in which “n” computers C1, C2 . . . Cn are provided each of which has a corresponding local memory m1, m2 . . . mn. The computers C1, C2 . . . Cn are interconnected by means of a communication system 5 which typically takes the form of a commercially available ETHERNET or similar. For the purposes of explanation, each of the individual memories is provided with 100 memory locations which are conveniently consecutively numbered so that the memory locations of the local memory m1 are 0-99, whilst the memory locations for the local memory m2 are numbered 100-199, etc. A characteristic of the DSM system is that each of the individual computers is able to access each of the memory locations of all the other computers in addition to its own memory locations. This architecture arrangement has the advantage of increasing the total memory available to all the computers, however, it does result in slowing of the computational speed of the multiple computer system because of the need for memory reads and memory writes to take place from one computer to another via the communications system 5.

The embodiments will be described with reference to the JAVA language, however, it will be apparent to those skilled in the art that the invention is not limited to this language and, in particular can be used with other languages (including procedural, declarative and object oriented languages) including the MICROSOFT.NET platform and architecture (Visual Basic, Visual C, and Visual C++, and Visual C#), FORTRAN, C, C++, COBOL, BASIC and the like.

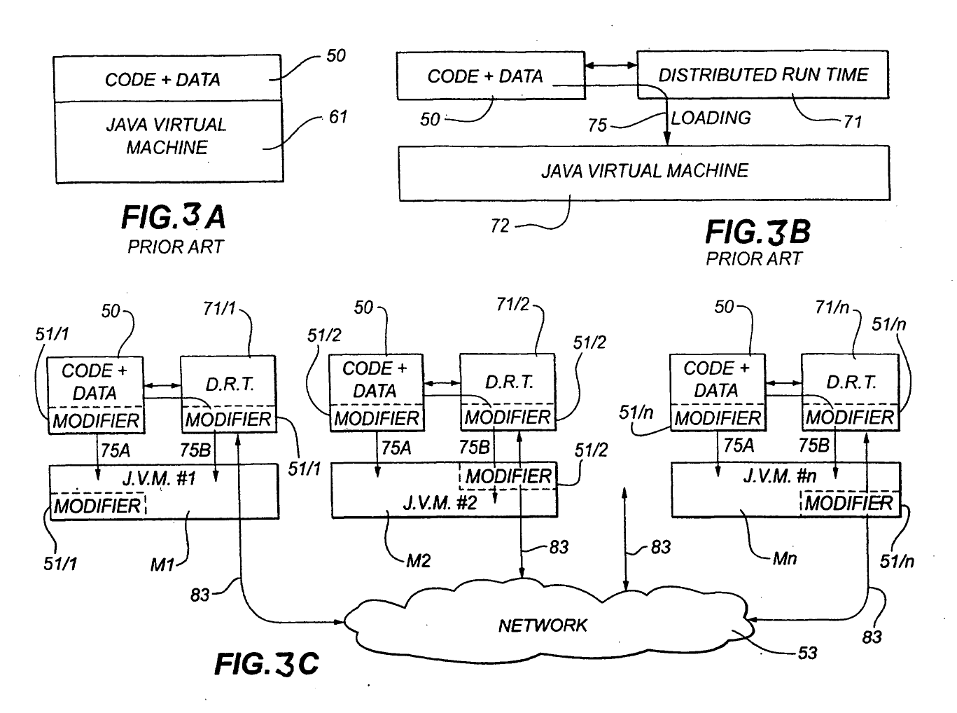

It is known in the prior art to provide a single computer or machine (produced by any one of various manufacturers and having an operating system (or equivalent control software or other mechanism) operating in any one of various different languages) utilizing the particular language of the application by creating a virtual machine as illustrated in FIG. 3A.

The code and data and virtual machine configuration or arrangement of FIG. 3A takes the form of the application code 50 written in the JAVA language and executing within the JAVA virtual machine 61. Thus where the intended language of the application is the language JAVA, a JAVA virtual machine is used which is able to operate code in JAVA irrespective of the machine manufacturer and internal details of the computer or machine. For further details, see “The JAVA Virtual Machine Specification” 2^{nd} Edition by T. Lindholm and F. Yellin of Sun Microsystems Inc of the USA which is incorporated herein by reference.

This conventional art arrangement of FIG. 3A is modified by the present applicant by the provision of an additional facility which is conveniently termed a “distributed run time” or a “distributed run time system” DRT 71 and as seen in FIG. 3B.

In FIGS. 3B and 3C, the application code 50 is loaded onto the Java Virtual Machine(s) M1, M2, . . . Mn in cooperation with the distributed runtime system 71, through the loading procedure indicated by arrow 75 or 75A or 75B. As used herein the terms “distributed runtime” and the “distributed run time system” are essentially synonymous, and by means of illustration but not limitation are generally understood to include library code and processes which support software written in a particular language running on a particular platform. Additionally, a distributed runtime system may also include library code and processes which support software written in a particular language running within a particular distributed computing environment. A runtime system (whether a distributed runtime system or not) typically deals with the details of the interface between the program and the operating system such as system calls, program start-up and termination, and memory management. For purposes of background, a conventional Distributed Computing Environment (DCE) (that does not provide the capabilities of the inventive distributed run time or distributed run time system 71 used in the preferred embodiments of the present invention) is available from the Open Software Foundation. This Distributed Computing Environment (DCE) performs a form of computer-to-computer communication for software running on the machines, but among its many limitations, it is not able to implement the desired modification or communication operations. Among its functions and operations the preferred DRT 71 coordinates the particular communications between the plurality of machines M1, M2, . . . Mn. Moreover, the preferred distributed runtime 71 comes into operation during the loading procedure indicated by arrow 75A or 75B of the JAVA application 50 on each JAVA virtual machine 72 or machines JVM#1, JVM#2, . . . JVM#n of FIG. 3C. It will be appreciated in light of the description provided herein that although many examples and descriptions are provided relative to the JAVA language and JAVA virtual machines so that the reader may get the benefit of specific examples, there is no restriction to either the JAVA language or JAVA virtual machines, or to any other language, virtual machine, machine or operating environment.

FIG. 3C shows in modified form the arrangement of the JAVA virtual machines, each as illustrated in FIG. 3B. It will be apparent that again the same application code 50 is loaded onto each machine M1, M2 . . . Mn. However, the communications between each machine M1, M2 . . . Mn are as indicated by arrows 83, and although physically routed through the machine hardware, are advantageously controlled by the individual DRT's 71/1 . . . 71/n within each machine. Thus, in practice this may be conceptionalised as the DRT's 71/1, . . . 71/n communicating with each other via the network or other communications link 53 rather than the machines M1, M2 . . . Mn communicating directly themselves or with each other. Contemplated and included are either this direct communication between machines M1, M2 . . . Mn or DRT's 71/1, 71/2 . . . 71/n or a combination of such communications. The preferred DRT 71 provides communication that is transport, protocol, and link independent.

The one common application program or application code 50 and its executable version (with likely modification) is simultaneously or concurrently executing across the plurality of computers or machines M1, M2 . . . Mn. The application program 50 is written to execute on a single machine or computer (or to operate on the multiple computer system of the abovementioned patent applications which emulate single computer operation). Essentially the modified structure is to replicate an identical memory structure and contents on each of the individual machines.

The term “common application program” is to be understood to mean an application program or application program code written to operate on a single machine, and loaded and/or executed in whole or in part on each one of the plurality of computers or machines M1, M2 . . . Mn, or optionally on each one of some subset of the plurality of computers or machines M1, M2 . . . Mn. Put somewhat differently, there is a common application program represented in application code 50. This is either a single copy or a plurality of identical copies each individually modified to generate a modified copy or version of the application program or program code. Each copy or instance is then prepared for execution on the corresponding machine. At the point after they are modified they are common in the sense that they perform similar operations and operate consistently and coherently with each other. It will be appreciated that a plurality of computers, machines, information appliances, or the like implementing the above described arrangements may optionally be connected to or coupled with other computers, machines, information appliances, or the like that do not implement the above described arrangements.

The same application program 50 (such as for example a parallel merge sort, or a computational fluid dynamics application or a data mining application) is run on each machine, but the executable code of that application program is modified on each machine as necessary such that each executing instance (copy or replica) on each machine coordinates its local operations on that particular machine with the operations of the respective instances (or copies or replicas) on the other machines such that they function together in a consistent, coherent and coordinated manner and give the appearance of being one global instance of the application (i.e. a “meta-application”).

The copies or replicas of the same or substantially the same application codes, are each loaded onto a corresponding one of the interoperating and connected machines or computers. As the characteristics of each machine or computer may differ, the application code 50 may be modified before loading, or during the loading process, or with some disadvantages after the loading process, to provide a customization or modification of the application code on each machine. Some dissimilarity between the programs or application codes on the different machines may be permitted so long as the other requirements for interoperability, consistency, and coherency as described herein can be maintained. As it will become apparent hereafter, each of the machines M1, M2 . . . Mn and thus all of the machines M1, M2 . . . Mn have the same or substantially the same application code 50, usually with a modification that may be machine specific.

Before the loading of, or during the loading of, or at any time preceding the execution of, the application code 50 (or the relevant portion thereof) on each machine M1, M2 . . . Mn, each application code 50 is modified by a corresponding modifier 51 according to the same rules (or substantially the same rules since minor optimizing changes are permitted within each modifier 51/1, 51/2 . . . 51/n).

Each of the machines M1, M2 . . . Mn operates with the same (or substantially the same or similar) modifier 51 (in some embodiments implemented as a distributed run time or DRT71 and in other embodiments implemented as an adjunct to the application code and data 50, and also able to be implemented within the JAVA virtual machine itself). Thus all of the machines M1, M2 . . . Mn have the same (or substantially the same or similar) modifier 51 for each modification required. A different modification, for example, may be required for memory management and replication, for initialization, for finalization, and/or for synchronization (though not all of these modification types may be required for all embodiments).

There are alternative implementations of the modifier 51 and the distributed run time 71. For example, as indicated by broken lines in FIG. 3C, the modifier 51 may be implemented as a component of or within the distributed run time 71, and therefore the DRT 71 may implement the functions and operations of the modifier 51. Alternatively, the function and operation of the modifier 51 may be implemented outside of the structure, software, firmware, or other means used to implement the DRT 71 such as within the code and data 50, or within the JAVA virtual machine itself. In one embodiment, both the modifier 51 and DRT 71 are implemented or written in a single piece of computer program code that provides the functions of the DRT and modifier. In this case the modifier function and structure is, in practice, subsumed into the DRT. Independent of how it is implemented, the modifier function and structure is responsible for modifying the executable code of the application code program, and the distributed run time function and structure is responsible for implementing communications between and among the computers or machines. The communications functionality in one embodiment is implemented via an intermediary protocol layer within the computer program code of the DRT on each machine. The DRT can, for example, implement a communications stack in the JAVA language and use the Transmission Control Protocol/Internet Protocol (TCP/IP) to provide for communications or talking between the machines. These functions or operations may be implemented in a variety of ways, and it will be appreciated in light of the description provided herein that exactly how these functions or operations are implemented or divided between structural and/or procedural elements, or between computer program code or data structures, is not important or crucial.

However, in the arrangement illustrated in FIG. 3C, a plurality of individual computers or machines M1, M2 . . . Mn are provided, each of which are interconnected via a communications network 53 or other communications link. Each individual computer or machine is provided with a corresponding modifier 51. Each individual computer is also provided with a communications port which connects to the communications network. The communications network 53 or path can be any electronic signalling, data, or digital communications network or path and is preferably a slow speed, and thus low cost, communications path, such as a network connection over the Internet or any common networking configurations including ETHERNET or INFINIBAND and extensions and improvements, thereto. Preferably, the computers are provided with one or more known communications ports (such as CISCO Power Connect 5224 Switches) which connect with the communications network 53.

As a consequence of the above described arrangement, if each of the machines M1, M2, . . . , Mn has, say, an internal or local memory capability of 10 MB, then the total memory available to the application code 50 in its entirety is not, as one might expect, the number of machines (n) times 10 MB. Nor is it the additive combination of the internal memory capability of all n machines. Instead it is either 10 MB, or some number greater than 10 MB but less than n×10 MB. In the situation where the internal memory capacities of the machines are different, which is permissible, then in the case where the internal memory in one machine is smaller than the internal memory capability of at least one other of the machines, then the size of the smallest memory of any of the machines may be used as the maximum memory capacity of the machines when such memory (or a portion thereof) is to be treated as ‘common’ memory (i.e. similar equivalent memory on each of the machines M1 . . . Mn) or otherwise used to execute the common application code.

However, even though the manner that the internal memory of each machine is treated may initially appear to be a possible constraint on performance, how this results in improved operation and performance will become apparent hereafter. Naturally, each machine M1, M2 . . . Mn has a private (i.e. ‘non-common’) internal memory capability. The private internal memory capability of the machines M1, M2, . . . , Mn are normally approximately equal but need not be. For example, when a multiple computer system is implemented or organized using existing computers, machines, or information appliances, owned or operated by different entities, the internal memory capabilities may be quite different. On the other hand, if a new multiple computer system is being implemented, each machine or computer is preferably selected to have an identical internal memory capability, but this need not be so.

It is to be understood that the independent local memory of each machine represents only that part of the machine's total memory which is allocated to that portion of the application program running on that machine. Thus, other memory will be occupied by the machine's operating system and other computational tasks unrelated to the application program 50.

Non-commercial operation of a prototype multiple computer system indicates that not every machine or computer in the system utilises or needs to refer to (e.g. have a local replica of) every possible memory location. As a consequence, it is possible to operate a multiple computer system without the local memory of each machine being identical to every other machine, so long as the local memory of each machine is sufficient for the operation of that machine. That is to say, provided a particular machine does not need to refer to (for example have a local replica of) some specific memory locations, then it does not matter that those specific memory locations are not replicated in that particular machine.

It may also be advantageous to select the amounts of internal memory in each machine to achieve a desired performance level in each machine and across a constellation or network of connected or coupled plurality of machines, computers, or information appliances M1, M2, . . . , Mn. Having described these internal and common memory considerations, it will be apparent in light of the description provided herein that the amount of memory that can be common between machines is not a limitation.

In some embodiments, some or all of the plurality of individual computers or machines can be contained within a single housing or chassis (such as so-called “blade servers” manufactured by Hewlett-Packard Development Company, Intel Corporation, IBM Corporation and others) or the multiple processors (eg symmetric multiple processors or SMPs) or multiple core processors (eg dual core processors and chip multithreading processors) manufactured by Intel, AMD, or others, or implemented on a single printed circuit board or even within a single chip or chipset. Similarly, also included are computers or machines having multiple cores, multiple CPU's or other processing logic.

When implemented in a non-JAVA language or application code environment, the generalized platform, and/or virtual machine and/or machine and/or runtime system is able to operate application code 50 in the language(s) (possibly including for example, but not limited to any one or more of source-code languages, intermediate-code languages, object-code languages, machine-code languages, and any other code languages) of that platform and/or virtual machine and/or machine and/or runtime system environment, and utilize the platform, and/or virtual machine and/or machine and/or runtime system and/or language architecture irrespective of the machine or processor manufacturer and the internal details of the machine. It will also be appreciated that the platform and/or runtime system can include virtual machine and non-virtual machine software and/or firmware architectures, as well as hardware and direct hardware coded applications and implementations.

For a more general set of virtual machine or abstract machine environments, and for current and future computers and/or computing machines and/or information appliances or processing systems, and that may not utilize or require utilization of either classes and/or objects, the structure, method and computer program and computer program product are still applicable. Examples of computers and/or computing machines that do not utilize either classes and/or objects include for example, the x86 computer architecture manufactured by Intel Corporation and others, the SPARC computer architecture manufactured by Sun Microsystems, Inc and others, the Power PC computer architecture manufactured by International Business Machines Corporation and others, and the personal computer products made by Apple Computer, Inc., and others.

For these types of computers, computing machines, information appliances, and the virtual machine or virtual computing environments implemented thereon that do not utilize the idea of classes or objects, may be generalized for example to include primitive data types (such as integer data types, floating point data types, long data types, double data types, string data types, character data types and Boolean data types), structured data types (such as arrays and records), derived types, or other code or data structures of procedural languages or other languages and environments such as functions, pointers, components, modules, structures, reference and unions. These structures and procedures when applied in combination when required, maintain a computing environment where memory locations, address ranges, objects, classes, assets, resources, or any other procedural or structural aspect of a computer or computing environment are where required created, maintained, operated, and deactivated or deleted in a coordinated, coherent, and consistent manner across the plurality of individual machines M1, M2 . . . Mn.

This analysis or scrutiny of the application code 50 can take place either prior to loading the application program code 50, or during the application program code 50 loading procedure, or even after the application program code 50 loading procedure (or some combination of these). It may be likened to an instrumentation, program transformation, translation, or compilation procedure in that the application code can be instrumented with additional instructions, and/or otherwise modified by meaning-preserving program manipulations, and/or optionally translated from an input code language to a different code language (such as for example from source-code language or intermediate-code language to object-code language or machine-code language). In this connection it is understood that the term “compilation” normally or conventionally involves a change in code or language, for example, from source code to object code or from one language to another language. However, in the present instance the term “compilation” (and its grammatical equivalents) is not so restricted and can also include or embrace modifications within the same code or language. For example, the compilation and its equivalents are understood to encompass both ordinary compilation (such as for example by way of illustration but not limitation, from source-code to object code), and compilation from source-code to source-code, as well as compilation from object-code to object code, and any altered combinations therein. It is also inclusive of so-called “intermediary-code languages” which are a form of “pseudo object-code”.

By way of illustration and not limitation, in one arrangement, the analysis or scrutiny of the application code 50 takes place during the loading of the application program code such as by the operating system reading the application code 50 from the hard disk or other storage device, medium or source and copying it into memory and preparing to begin execution of the application program code. In another arrangement, in a JAVA virtual machine, the analysis or scrutiny may take place during the class loading procedure of the java.lang.ClassLoader.loadClass method (e.g. “java.lang.ClassLoader.loadClass( )”).

Alternatively, or additionally, the analysis or scrutiny of the application code 50 (or of a portion of the application code) may take place even after the application program code loading procedure, such as after the operating system has loaded the application code into memory, or optionally even after execution of the relevant corresponding portion of the application program code has started, such as for example after the JAVA virtual machine has loaded the application code into the virtual machine via the “java.lang.ClassLoader.loadClass( )” method and optionally commenced execution.

Persons skilled in the computing arts will be aware of various possible techniques that may be used in the modification of computer code, including but not limited to instrumentation, program transformation, translation, or compilation means and/or methods.

One such technique is to make the modification(s) to the application code, without a preceding or consequential change of the language of the application code. Another such technique is to convert the original code (for example, JAVA language source-code) into an intermediate representation (or intermediate-code language, or pseudo code), such as JAVA byte code. Once this conversion takes place the modification is made to the byte code and then the conversion may be reversed. This gives the desired result of modified JAVA code.

A further possible technique is to convert the application program to machine code, either directly from source-code or via the abovementioned intermediate language or through some other intermediate means. Then the machine code is modified before being loaded and executed. A still further such technique is to convert the original code to an intermediate representation, which is thus modified and subsequently converted into machine code. All such modification routes are envisaged and also a combination of two, three or even more, of such routes.

The DRT 71 or other code modifying means is responsible for creating or replicating a memory structure and contents on each of the individual machines M1, M2 . . . Mn that permits the plurality of machines to interoperate. In some arrangements this replicated memory structure will be identical. Whilst in other arrangements this memory structure will have portions that are identical and other portions that are not. In still other arrangements the memory structures are different only in format or storage conventions such as Big Endian or Little Endian formats or conventions.

These structures and procedures when applied in combination when required, maintain a computing environment where the memory locations, address ranges, objects, classes, assets, resources, or any other procedural or structural aspect of a computer or computing environment are where required created, maintained, operated, and deactivated or deleted in a coordinated, coherent, and consistent manner across the plurality of individual machines M1, M2 . . . Mn.

Therefore the terminology “one”, “single”, and “common” application code or program includes the situation where all machines M1, M2 . . . Mn are operating or executing the same program or code and not different (and unrelated) programs, in other words copies or replicas of same or substantially the same application code are loaded onto each of the interoperating and connected machines or computers.

In conventional arrangements utilising distributed software, memory access from one machine's software to memory physically located on another machine typically takes place via the network interconnecting the machines. Thus, the local memory of each machine is able to be accessed by any other machine and therefore cannot be said to be independent. However, because the read and/or write memory access to memory physically located on another computer require the use of the slow network interconnecting the computers, in these configurations such memory accesses can result in substantial delays in memory read/write processing operations, potentially of the order of 10⁶-10⁷ cycles of the central processing unit of the machine (given contemporary processor speeds). Ultimately this delay is dependent upon numerous factors, such as for example, the speed, bandwidth, and/or latency of the communication network. This in large part accounts for the diminished performance of the multiple interconnected machines in the prior art arrangement.

However, in the present arrangement all reading of memory locations or data is satisfied locally because a current value of all (or some subset of all) memory locations is stored on the machine carrying out the processing which generates the demand to read memory.

Similarly, all writing of memory locations or data is satisfied locally because a current value of all (or some subset of all) memory locations is stored on the machine carrying out the processing which generates the demand to write to memory.

Such local memory read and write processing operation can typically be satisfied within 10²-10³ cycles of the central processing unit. Thus, in practice there is substantially less waiting for memory accesses which involves and/or writes. Also, the local memory of each machine is not able to be accessed by any other machine and can therefore be said to be independent.

The arrangement is transport, network, and communications path independent, and does not depend on how the communication between machines or DRTs takes place. Even electronic mail (email) exchanges between machines or DRTs may suffice for the communications.

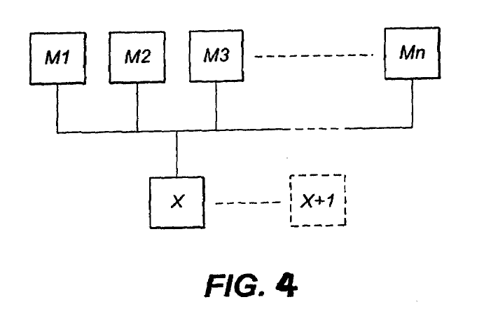

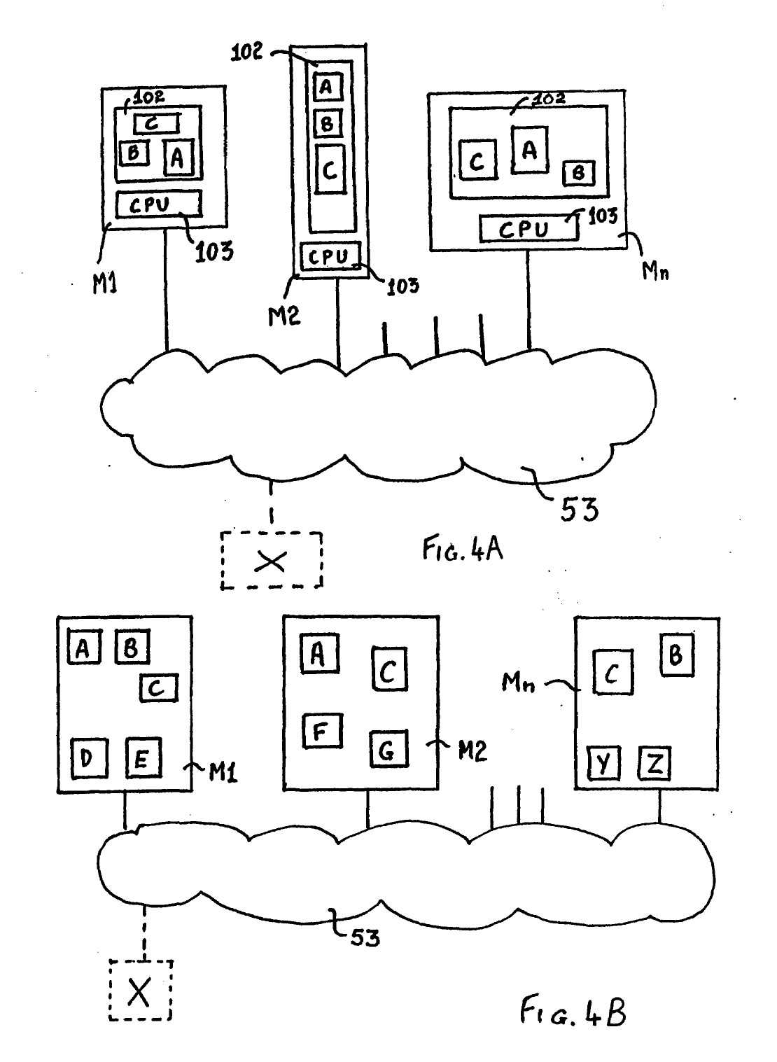

In connection with the above, it will be seen from FIG. 4 that there are a number of machines M1, M2, . . . Mn, “n” being an integer greater than or equal to two, on which the application program 50 of FIG. 3A is being run substantially simultaneously. These machines are allocated a number 1, 2, 3, . . . etc. in a hierarchical order. This order is normally looped or closed so that whilst machines 2 and 3 are hierarchically adjacent, so too are machines “n” and 1. There is preferably a further machine X which is provided to enable various housekeeping functions to be carried out, such as acting as a lock server. In particular, the further machine X can be a low value machine, and much less expensive than the other machines which can have desirable attributes such as processor speed. Furthermore, an additional low value machine (X+1) is preferably available to provide redundancy in case machine X should fail. Where two such server machines X and X+1 are provided, they are preferably, for reasons of simplicity, operated as dual machines in a cluster configuration. Machines X and X+1 could be operated as a multiple computer system in accordance with the above described arrangments, if desired. However this would result in generally undesirable complexity. If the machine X is not provided then its functions, such as housekeeping functions, are provided by one, or some, or all of the other machines.

FIG. 4A is a schematic diagram of a replicated shared memory system. In FIG. 4A three machines are shown, of a total of “n” machines (n being an integer greater than one) that is machines M1, M2, . . . Mn. Additionally, a communications network 53 is shown interconnecting the three machines and a preferable (but optional) server machine X which can also be provided and which is indicated by broken lines. In each of the individual machines, there exists a memory 102 and a CPU 103. In each memory 102 there exists three memory locations, a memory location A, a memory location B, and a memory location C. Each of these three memory locations is replicated in a memory 102 of each machine.

This arrangement of the replicated shared memory system allows a single application program written for, and intended to be run on, a single machine, to be substantially simultaneously executed on a plurality of machines, each with independent local memories, accessible only by the corresponding portion of the application program executing on that machine, and interconnected via the network 53. In International Patent Application No PCT/AU2005/001641 (WO2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds, a technique is disclosed to detect modifications or manipulations made to a replicated memory location, such as a write to a replicated memory location A by machine M1 and correspondingly propagate this changed value written by machine M1 to the other machines M2. Mn which each have a local replica of memory location A. This result is achieved by detecting write instructions in the executable object code of the application to be run that write to a replicated memory location, such as memory location A, and modifying the executable object code of the application program, at the point corresponding to each such detected write operation, such that new instructions are inserted to additionally record, mark, tag, or by some such other recording means indicate that the value of the written memory location has changed.

An alternative arrangement is that illustrated in FIG. 4B and termed partial or hybrid replicated shared memory (RSM). Here memory location A is replicated on computers or machines M1 and M2, memory location B is replicated on machines M1 and Mn, and memory location C is replicated on machines M1, M2 and Mn. However, the memory locations D and E are present only on machine M1, the memory locations F and G are present only on machine M2, and the memory locations Y and Z are present only on machine Mn. Such an arrangement is disclosed in Australian Patent Application No. 2005 905 582 Attorney Ref 5027I (to which U.S. patent application Ser. No. 11/583,958 (60/730,543) and PCT/AU2006/001447 (WO2007/041762) correspond). In such a partial or hybrid RSM systems changes made by one computer to memory locations which are not replicated on any other computer do not need to be updated at all. Furthermore, a change made by any one computer to a memory location which is only replicated on some computers of the multiple computer system need only be propagated or updated to those some computers (and not to all other computers).

Consequently, for both RSM and partial RSM, a background thread task or process is able to, at a later stage, propagate the changed value to the other machines which also replicate the written to memory location, such that subject to an update and propagation delay, the memory contents of the written to memory location on all of the machines on which a replica exists, are substantially identical. Various other alternative embodiments are also disclosed in the abovementioned specification.

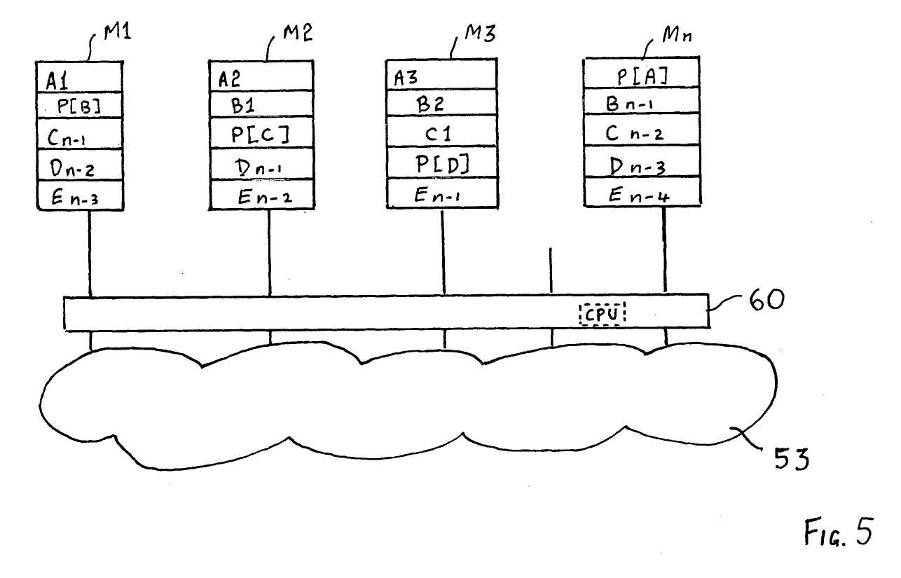

Turning now to FIG. 5, an embodiment of a distributed shared memory (DSM) system in accordance with the present invention is illustrated which is somewhat analogous to, yet different from, the RAID arrangement of FIG. 1. Here the multiple computer system has “n” machines or computers M1, M2, M3 . . . Mn where “n” is an integer greater than or equal to 2. These computers are interconnected via a communications network 53. In addition, in this embodiment, interposed between the network 53 and the computers M1, M2 . . . Mn is a router 60. The router 60 includes logic which decides where and in what manner data is stored (and hence read subsequently). The router 60 may or may not include a central processing unit (CPU) and this is therefore indicated in phantom. The router 60 can also function as a failure detector.

In FIG. 5 the memory architecture is such that in the “n” computers a given piece of data A is divided (for example by the router 60) into (n−1) pieces which are then stored on computers M1, M2 . . . Mn−1 respectively. In addition, a parity form of these individual data pieces is formed and stored in the remaining computer Mn. In the arrangement illustrated in FIG. 5, the parity form of data stored in machine Mn is represented as P[A] but can be thought of as being composed as follows:

P[A]=P(A+A2+A3+ . . . +An−2+An−1)

Similarly, another data piece B is divided into (n−1) pieces and stored as B1, B2, etc plus P[B]. This procedure is repeated for the other data items C, D, E, etc.

In the event that a particular computer issues a request to read, say, data B, then the router 60 reads the individual data pieces B1, B2 . . . Bn−1 and thus assembles the data B. It is not necessary to read the parity form P[B].

Whilst it would be possible to store all the data items A1, B1, C1, etc on computer M1, and all the data items A2, B2, C2, etc on computer M2, and all the parity forms P[A], P[B], P[C], etc on computer Mn, this is generally not desirable. Instead it is preferred to cycle the information among all the computers in the manner indicated in FIG. 5. This cycling increases the ease of data reconstruction in the event of failure of one of the machines.

In the event that a particular computer, say M2, should fail, then no action is required to reconstitute data C because each of the data items C1, C2 . . . Cn−1 can be read from computers M3, M4 . . . Mn, M1 respectively. However, in respect of the other data such as data A, the data item A2 is lost and so must be re-generated by reading the data items A1, A3, A4 . . . An−1 and P[A]. Then the reverse of the algorithm used to generate P[A] is applied and A2 re-generated by successive removal of A1, A3, A4, etc until only the value which constitutes the missing item A2 remains. A similar procedure is carried out for the data items B, D and E.

If all the parity forms P[A], P[B], P[C], etc had all been stored on the same computer (say Mn), this would result in no action being required if computer Mn failed, but every data item being re-generated in the event that any one of the computers M1, M2 . . . Mn−1 failed. Thus an advantage of cycling the parity forms P[A], P[B] etc around the various computers is that the volume of re-generation is less because the failed computer will have included some parity forms which will not require re-generation.

The above-mentioned failure is able to be detected by a conventional detector attached to each of the application program running machines and reporting to machine X, for example.

Such a detector is commercially available as a Simple Network Management Protocol (SNMP). This is essentially a small program which operates in the background and provides a specified output signal in the event that failure is detected.

Such a detector is able to sense failure in a number of ways, any one, or more, of which can be used simultaneously. For example, machine X can interrogate each of the other machines M1, M2, . . . Mn in turn requesting a reply. If no reply is forthcoming after a predetermined time, or after a small number of “reminders” are sent, also without reply, the non-responding machine is pronounced “dead”.

Alternatively, or additionally, each of the machines M1, . . . Mn can at regular intervals, say every 30 seconds, send a predetermined message to machine X (or to all other machines in the absence of a server) to say that all is well. In the absence of such a message the machine can be presumed “dead” or can be interrogated (and if it then fails to respond) is pronounced “dead”.

Further methods include looking for a turn on event in an uninterruptible power supply (UPS) used to power each machine which therefore indicates a failure of mains power. Similarly, conventional switches such as those manufactured by CISCO of California, USA include a provision to check either the presence of power to the communications network 53, or whether the network cable is disconnected.

In some circumstances, for example for enhanced redundancy or for increased bandwidth, each individual machine can be “multi-peered” which means there are two or more links between the machine and the communications network 53. An SNMP product which provides two options in this circumstance-namely wait for both/all links to fail before signalling machine failure, or signal machine failure if any one link fails, is the 12 Port Gigabit Managed Switch GSM 7212 sold under the trade marks NETGEAR and PROSAFE.

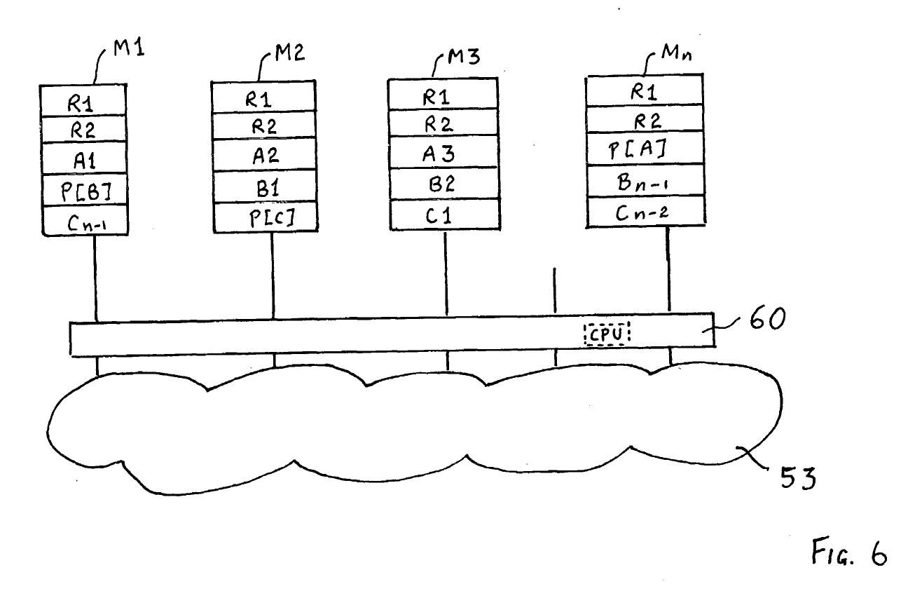

Turning now to FIG. 6 an embodiment of a replicated shared memory system (RSM) in accordance with the present invention, and in particular a hybrid or partial replicated shared memory system, is illustrated. An RSM system is disclosed in the abovementioned PCT applications which have been incorporated herein by cross-reference. A partial or hybrid RSM system is disclosed in co-pending International Application No. PCT/AU2007/ . . . (Attorney Ref 5027Y-WO) claiming priority from Australian Patent Application No. 2006 905, 534 entitled “Hybrid Replicated Shared Memory” (Attorney Reference 5027Y by the present applicant and to which U.S. Provisional Patent Application No. 60/850,537 having the same title corresponds). In addition, a partial or hybrid RSM system is also disclosed in Australian Patent Application Nos. 2005 905 581 entitled “Modified Machine Architecture with Enhanced Memory Clean Up” (Attorney Reference 5027J) lodged 10 Oct. 2005 (to which PCT/AU2006/001448 (WO2007/041763) and U.S. patent application Ser. No. 11/583,991 60/730,408) corresponds) and 2005 905 582 entitled “Modified Machine Architecture with Partial Memory Updating” (Attorney Reference 5026I) lodged 10 Oct. 2005 (to which PCT/AU2006/001447 (WO2007/041762) and U.S. patent application Ser. No. 11/583,958 (60/730,543) corresponds). The contents of all these specifications are hereby incorporated into the present specification for all purposes by cross-reference.

Briefly stated these specifications disclose a multiple computer system in which some memory locations (including objects, fields, arrays, etc) are replicated on each of the computers which executes a portion of the application code 50, but other memory locations (including objects, fields, arrays, etc) are not replicated. The non-replicated memory locations are only required for processing by the individual computer where the memory location forms part of the independent local memory.

Thus, in the arrangement of FIG. 6, of the five memory locations illustrated in the computers M1, M2 . . . Mn, the first two memory locations R1 and R2 are replicated and are thus the same for each computer. The remaining memory locations are then arranged as described above in relation to FIG. 5.

Clearly, in the event of failure of one of the computers M1, M2 . . . Mn of FIG. 6, then the replicated memory locations such as R1 and R2 are not “lost” by the failure since they are available on all the other computers. The recovery of the contents of those memory locations which are not replicated in FIG. 6 proceeds in the manner described above in relation to FIG. 5.

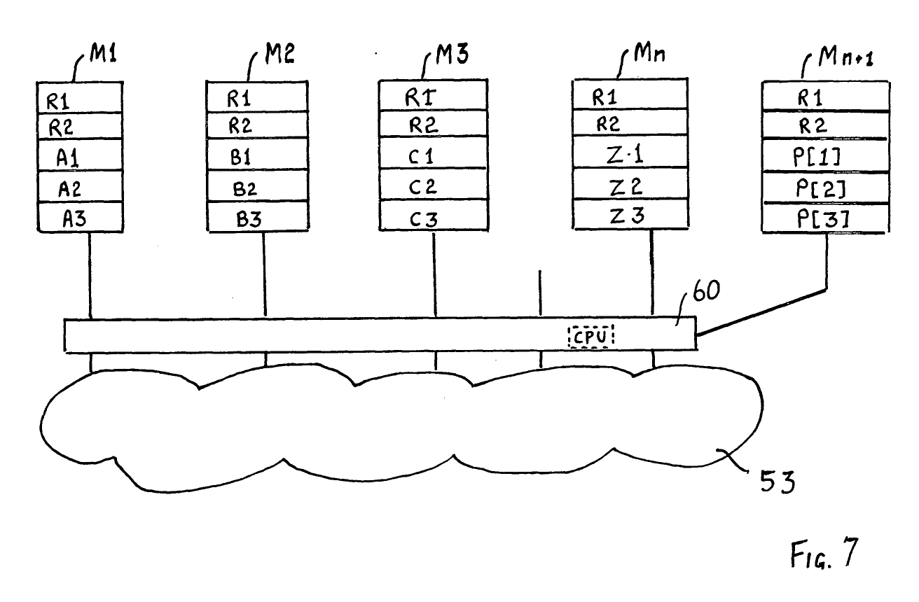

Turning now to FIG. 7, a still further embodiment of hybrid or partial replicated shared memory system in accordance with the present invention is illustrated. Here “n” multiple computers M1, M2, . . . Mn are provided each of which has replicated memory locations such as R1 and R2 which are common to all machines and which are maintained updated via the network 53.

In addition, each machine has independent local memory locations such as A1, A2, A3, B1, B2, B3, . . . Z1, Z2, and Z3 which are only accessible by the corresponding local machine M1, M2, . . . Mn.

In this embodiment an additional machine Mn+1 is provided for the purpose of providing redundancy. Again machine Mn+1 includes the replicated memory locations R1, R2 etc. but need not do so. Also the router 60 is provided and its task is to send to the machine Mn+1 the contents of the non-replicated memory locations so that a parity form thereof can be created and stored.

Thus in this embodiment the contents of the first non-replicated memory locations of each of the “n” machines (that is the contents of memory locations A1, B1, C1, . . . Z1) are sent by router 60 to the additional machine Mn+1.

The additional machine Mn+1 then prepares a parity form of this data which is represented as P[1] in FIG. 7 and which is stored in the corresponding first location in machine Mn+1. Similarly, the parity form P[2] is prepared from the contents of memory locations A2, B2, C2, . . . Z2 and so on.

As the execution of each of the application running machines M1, M2, . . . Mn progresses, so the contents of the non-replicated memory locations A1, A2, . . . Z2, Z3, etc. will, from time to time, change. These changes are transmitted by the router 60 to the machine Mn+1 and the corresponding parity form of stored data P[1], P[2], etc. is also updated with the changes.

In the event of failure of machine Mn+1, this does not disrupt the running of the multiple computer system formed by machines M1, M2, . . . Mn and the execution of the application program 50 continues. All that is lost is some measure of redundancy.

However, in the event that one of the “n” application running machines, say M3, should fail then the computational load of the failed machine can be initially transferred to another machine (such as M2) and then the loads of all the remaining machines M1, M2, M4, . . . Mn substantially equalized.

In particular, the contents of the parity data forms P[1], P[2], etc. stored on machine Mn+1 can be used to re-constitute the lost data of memory locations C1, C2, C3 etc. present on machine M3 at the time of its failure.

An advantage of the embodiment of FIG. 7 is that the additional computer Mn+1 can, if desired, be a low cost computer and less expensive (and less capable) than each of the “n” application running computers M1, M2, . . . Mn.

To summarize there is disclosed a method of storing data in a multiple computer system comprising a multiplicity of computers each having an independent local memory and each being interconnected to the other computers via a communications network, the method comprising the steps of:

(i) partitioning the local application memory of each computer into a corresponding multiplicity of application memory compartments,
(ii) dividing data created by, or required for, the operation of the multiple computers into a plurality of groups being one less in number than the number of compartments,
(iii) applying a reversible encoding technique to each of the data groups to create an additional data group comprising a decodable encoding of the other groups, and
(iv) storing a different one of each of the groups in a corresponding compartment in each the computer,
whereby in the event of failure of only one of the computers the divided data can be re-constituted from the data stored in the remaining computers.

Preferably the method includes the further step of:

(v) carrying out steps (ii) and (iii) to each of several different portions of data to create a corresponding number of different data groups each including an additional data group, and
(vi) storing the different data groups to distribute the additional data groups amongst the multiplicity of computers.

Preferably the method includes the step of:

(vii) storing the data in distributed manner amongst the multiplicity of computers whereby the data stored on each computer is accessible by all the computers to thereby form a distributed shared memory system.

Alternatively the method includes the step of:

(viii) storing some of the data as a replica in each the computer to thereby form a partial replicated shared memory system.

Preferably the non-replicated data and the encoded additional data are distributed amongst the multiplicity of computers.

Preferably one of the multiplicity of computers stores all of the encoded additional data.

Preferably the one computer stores none of the non-replicated data.

Preferably the method includes the step of interposing a router between the multiplicity of computers and the communications network.

In addition there is disclosed a multiple computer system comprising a multiplicity of computers each having an independent local memory and each being interconnected to the other computers via a communications network, the local application memory of each computer being partitioned into a corresponding multiplicity of application memory compartments, data division means to divide data created by, or required for, the operation of the multiple computers into a plurality of groups being one less in number than the number of the compartments, and data encoding means to create an additional data group comprising a decodable encoding of the other groups, wherein a different one of each of the groups is stored in a corresponding compartment in each the computer, whereby in the event of failure of only one of the computers the divided data can be reconstituted from the data stored in the remaining computers.

Preferably the divided data comprises a number of different data groups each corresponding to several different portions of data and each including an additional data group, the additional data groups being stored in distributed fashion amongst the multiplicity of computers.

Preferably the data is stored in distributed manner amongst the multiplicity of computers with the data stored on each computer being accessible by all the computers whereby the system comprises a distributed shared memory system.

Preferably at least some of the data is stored as a replica in each the computer whereby the system comprises a replicated shared memory system.

Preferably the non-replicated data and the encoded additional data are distributed amongst the multiplicity of computers.

Preferably one of the multiplicity of computers stores all of the encoded additional data.

Preferably the one computer stores none of the non-replicated data.

Preferably a router is interposed between the multiplicity of computers and the communications network.

In addition, there is also disclosed a single computer for use with an external multiple computer system including a multiplicity of computers, the single computer comprising an independent local memory partitioned into a multiplicity of application memory compartments corresponding to the multiplicity of computers in the multiple computer system, and a communications port adapted for coupling with an external network for interconnection with the external multiple computer system, the communications port receiving a divided data comprising a number of different data groups each corresponding to several different portions of data and each including an additional data group.

The foregoing describes only some embodiments of the present invention and modifications, obvious to those skilled in the art, can be made thereto without departing from the scope of the present invention. For example, reference to JAVA includes both the JAVA language and also JAVA platform and architecture.

In all described instances of modification, where the application code 50 is modified before, or during loading, or even after loading but before execution of the unmodified application code has commenced, it is to be understood that the modified application code is loaded in place of, and executed in place of, the unmodified application code subsequently to the modifications being performed.

Alternatively, in the instances where modification takes place after loading and after execution of the unmodified application code has commenced, it is to be understood that the unmodified application code may either be replaced with the modified application code in whole, corresponding to the modifications being performed, or alternatively, the unmodified application code may be replaced in part or incrementally as the modifications are performed incrementally on the executing unmodified application code. Regardless of which such modification routes are used, the modifications subsequent to being performed execute in place of the unmodified application code.

It is advantageous to use a global identifier is as a form of ‘meta-name’ or ‘meta-identity’ for all the similar equivalent local objects (or classes, or assets or resources or the like) on each one of the plurality of machines M1, M2 . . . Mn. For example, rather than having to keep track of each unique local name or identity of each similar equivalent local object on each machine of the plurality of similar equivalent objects, one may instead define or use a global name corresponding to the plurality of similar equivalent objects on each machine (e.g. “globalname7787”), and with the understanding that each machine relates the global name to a specific local name or object (e.g. “globalname7787” corresponds to object “localobject456” on machine M1, and “globalname7787” corresponds to object “localobject885” on machine M2, and “globalname7787” corresponds to object “localobject111” on machine M3, and so forth).

It will also be apparent to those skilled in the art in light of the detailed description provided herein that in a table or list or other data structure created by each DRT 71 when initially recording or creating the list of all, or some subset of all objects (e.g. memory locations or fields), for each such recorded object on each machine M1, M2 . . . Mn there is a name or identity which is common or similar on each of the machines M1, M2 . . . Mn. However, in the individual machines the local object corresponding to a given name or identity will or may vary over time since each machine may, and generally will, store memory values or contents at different memory locations according to its own internal processes. Thus the table, or list, or other data structure in each of the DRTs will have, in general, different local memory locations corresponding to a single memory name or identity, but each global “memory name” or identity will have the same “memory value or content” stored in the different local memory locations. So for each global name there will be a family of corresponding independent local memory locations with one family member in each of the computers. Although the local memory name may differ, the asset, object, location etc has essentially the same content or value. So the family is coherent.

The term “table” or “tabulation” as used herein is intended to embrace any list or organised data structure of whatever format and within which data can be stored and read out in an ordered fashion.

It will also be apparent to those skilled in the art in light of the description provided herein that the abovementioned modification of the application program code 50 during loading can be accomplished in many ways or by a variety of means. These ways or means include, but are not limited to at least the following five ways and variations or combinations of these five, including by:
(i) re-compilation at loading,
(ii) a pre-compilation procedure prior to loading,
(iii) compilation prior to loading,
(iv) “just-in-time” compilation(s), or
(v) re-compilation after loading (but, for example, before execution of the relevant or corresponding application code in a distributed environment).

Traditionally the term “compilation” implies a change in code or language, for example, from source to object code or one language to another. Clearly the use of the term “compilation” (and its grammatical equivalents) in the present specification is not so restricted and can also include or embrace modifications within the same code or language.

Those skilled in the computer and/or programming arts will be aware that when additional code or instructions is/are inserted into an existing code or instruction set to modify same, the existing code or instruction set may well require further modification (such as for example, by re-numbering of sequential instructions) so that offsets, branching, attributes, mark up and the like are properly handled or catered for.

Similarly, in the JAVA language memory locations include, for example, both fields and array types. The above description deals with fields and the changes required for array types are essentially the same mutatis mutandis. The above is equally applicable to similar programming languages (including procedural, declarative and object orientated languages) to JAVA including Microsoft.NET platform and architecture (Visual Basic, Visual C/C⁺⁺, and C#) FORTRAN, C/C⁺⁺, COBOL, BASIC etc.

The terms object and class used herein are derived from the JAVA environment and are intended to embrace similar terms derived from different environments such as dynamically linked libraries (DLL), or object code packages, or function unit or memory locations.

The above arrangements may be implemented by computer program code statements or instructions (possibly including by a plurality of computer program code statements or instructions) that execute within computer logic circuits, processors, ASICs, logic or electronic circuit hardware, microprocessors, microcontrollers or other logic to modify the operation of such logic or circuits to accomplish the recited operation or function. In another arrangement, the implementation may be in firmware and in other arrangements may be in hardware. Furthermore, any one or each of these various implementations may be a combination of computer program software, firmware, and/or hardware.

Any and each of the abovedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer in which it executes or on a computer coupled with, connected to, or otherwise in signal communications with the computer on which the computer program or computer program product is present or executing. Such a computer program or computer program product modifies the operation and architectural structure of the computer, computing machine, and/or information appliance to alter the technical operation of the computer and realize the technical effects described herein.

The invention may therefore be constituted by a computer program product comprising a set of program instructions stored in a storage medium or existing electronically in any form and operable to permit a plurality of computers to carry out any of the methods, procedures, routines, or the like as described herein including in any of the claims.

Furthermore, the invention includes (but is not limited to) a plurality of computers, or a single computer adapted to interact with a plurality of computers, interconnected via a communication network or other communications link or path and each operable to substantially simultaneously or concurrently execute the same or a different portion of an application code written to operate on only a single computer on a corresponding different one of computers. The computers are programmed to carry out any of the methods, procedures, or routines described in the specification or set forth in any of the claims, on being loaded with a computer program product or upon subsequent instruction. Similarly, the invention also includes within its scope a single computer arranged to co-operate with like, or substantially similar, computers to form a multiple computer system

The term “comprising” (and its grammatical variations) as used herein is used in the inclusive sense of “having” or “including” and not in the exclusive sense of “consisting only of”.

1. A single computer for use with an external multiple computer system that includes a multiplicity of computers, the single computer comprising:
an independent local memory partitioned into a multiplicity of application memory compartments corresponding to the multiplicity of computers in the multiple computer system; and
a communications port adapted for coupling with an external network for interconnection with the external multiple computer system, said communications port receiving a divided data comprising a number of different data groups each corresponding to several different portions of data and each including an additional data group.

2. A method of operating a single computer for use with an external multiple computer system that includes a multiplicity of computers, the method comprising:
operating or enabling operation of an independent local memory within said single computer;
partitioning said independent local memory into a multiplicity of application memory compartments corresponding to the multiplicity of computers in the external multiple computer system; and
operating or enabling operation of a communications port coupled with said single computer and adapted for coupling with an external network for interconnection with the external multiple computer system;
receiving a divided data from said communications port comprising a number of different data groups each corresponding to several different portions of data and each including an additional data group; and
storing said received and divided data in said local memory.

3. A computer program stored in a computer readable media, the computer program including executable computer program instructions and adapted for execution by at least one computer to modify the operation of at least one computer; the modification of operation including performing method of operating a single computer for use with an external multiple computer system that includes a multiplicity of computers, the method comprising:
operating or enabling operation of an independent local memory within said single computer;
partitioning said independent local memory into a multiplicity of application memory compartments corresponding to the multiplicity of computers in the external multiple computer system; and
operating or enabling operation of a communications port coupled with said single computer and adapted for coupling with an external network for interconnection with the external multiple computer system;
receiving a divided data from said communications port comprising a number of different data groups each corresponding to several different portions of data and each including an additional data group; and
storing said received and divided data in said local memory.

4. A data structure for a single computer adapted for communication to an external multiple computer system including external multiplicity of computers, said single computer data structure comprising:
a local computer application memory partitioned into a multiplicity of application memory compartments corresponding to the number of computers in the external multiple computer system;
the data created by, or required for, the operation of said single computer in said local application memory being divided into a plurality of groups, the number in the plurality of groups being one less in number than the number of said compartments; and
an additional data group being created by data encoding and stored to create an additional data group comprising a decodable encoding of the other groups.

5. A data structure for a single computer as in claim 20, wherein said single computer consists of exactly one computer.

6. A data structure for a single computer as in claim 21, wherein said exactly one computer comprises one or a plurality of processors contained within a single computer housing.
